(19) United States
(12) Patent Application Publication
(10) Pub. No.: US 2014/0096334 A1
(43) Pub. Date: Apr. 10, 2014

(54) PAINT APPLICATOR

(71) Applicant: NOVA WILDCAT SHUR-LINE, LLC, Mooresville, NC (US)

(72) Inventor: Gary DeCarr, Fort Mill, SC (US)

(73) Assignee: NOVA WILDCAT SHUR-LINE, LLC, MOORESVILLE, NC (US)

(21) Appl. No.: 14/048,606

(22) Filed: Oct. 8, 2013

Related U.S. Application Data
(60) Provisional application No. 61/711,013, filed on Oct. 8, 2012.

(51) Int. Cl. B05C 17/02; B32B 37/14

(52) U.S. Cl. CPC B05C 17/0207; B32B 37/14
USPC 15/230; 156/60; 156/244.18; 156/183; 156/148; 15/209.1

(57) ABSTRACT

An applicator includes a cylindrical core having an interior surface and an exterior surface. A backing layer is attached to at least a portion of the exterior surface of the cylindrical core. A fabric material is attached to at least a portion of the backing layer. The fabric material is formed of polytetrafluoroethylene (PTFE).

### CROSS-REFERENCE TO RELATED APPLICATIONS

The present application claims priority to U.S. Provisional Application No. 61/711,013 filed on Oct. 8, 2012 and entitled “PTFE FIBER PAINT ROLLER,” which is herein incorporated by reference in its entirety.

### DESCRIPTION OF THE INVENTION

The present disclosure is generally directed to paint applicators, and more particularly to paint roller covers that exhibit improved retention and/or release of paint.

Paint roller covers typically include a fabric material that can affect the quality of a roller cover and/or the type of target surface finish desired and the paint to be applied to a target surface, such as a wall.

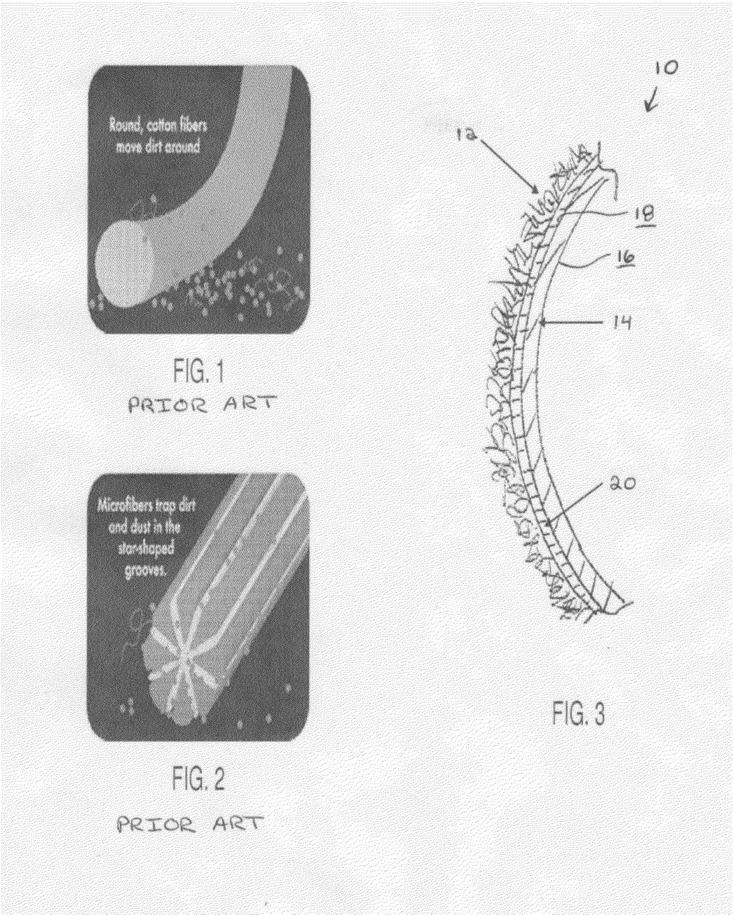

As shown in FIG. 1, a typical fiber, such as those used for form a roller cover, may have a circular or round cross section. Such a fiber structure is generally poor at retaining or picking-up substances, such as paint. Thus, some fibers are created to include eccentric or non-linear configurations to create irregular gaps and spaces between fibers and pockets among closely spaced fibers. These pockets and gaps can help retain substances that come in contact with a fabric of the fibers. However, retention may not be adequate for some intended purposes or to meet desired performance criteria for a given application.

Some manufacturers split fibers along their length to create small diameter or low weight microfibers. Microfibers are generally, though not always, 1 μm or less in denier. Denier is a unit measure of weight. Denier often can be translated to fiber diameter, but due to different molecular weights of material, Denier diameter measure may only be relevant when comparing the same materials. When fibers are split to create the microfibers, the surface characteristics or cross-section shape of the material changes in cross-section, depending on the base fiber material utilized. For example, polyester fibers typically formed a wedge shape when split to create microfibers. Nylon fibers will typically be produced form a star-shaped microfiber in cross-section, as shown in FIG. 2. Because of the irregular surface of the microfiber structure, microfibers are generally very good at picking up substances, but not very good at releasing such substances, once picked-up. Microfibers also may break under load, and thus may lack suitable durability.

To enhance release performance, some manufacturers utilize a secondary manufacturing process wherein the conventional fibers or yarn are coated/treated with an additional material layer that improves the release capability of the fibers or yarn material. Such coated fibers are used on paint roller covers for picking up and releasing paint from the fabric. The nonlinear or bent configuration of the fibers is utilized to retain paint within the fabric until release and the coating layer is applied to enhance release of the paint. Typically, the secondary coating material is polytetrafluoroethylene (PTFE) or TEFLON®. However, this secondary manufacturing process and the second material itself that is required to coat the base fiber material further increase the cost and manufacturing complexity of the roller covers.

Accordingly, there is a need in the art for solutions that maximize retention and/or release performance, and are not cost prohibitive for consumers. A product obtained in a single manufacturing process with an appropriate material or combination of materials is discussed herein and overcomes at least certain disadvantages of the prior art.

The foregoing summary, as well as the following description, will be better understood when read in conjunction with the appended drawings illustrating various embodiments. It should be understood, however, that the invention is not limited to the precise arrangements and instrumentalities shown. In the drawings:

FIG. 1 is a perspective view of a portion of a fiber structure according to the prior art;

FIG. 2 is a perspective view of a portion of a microfiber structure according to the prior art; and

FIG. 3 is a cross-sectional elevation view of a portion of a paint applicator according to an embodiment of the present disclosure.

Certain terminology is used in the following description for convenience only and is not intended to be limiting. The terminology used herein includes the explicit words used, derivatives thereof and words of similar import. Unless specifically set forth herein, the terms “a,” “an” and “the” are not limited to one element, but instead should be read as “at least one.”

Referring to the drawings in detail, wherein like numerals indicate like elements throughout, FIG. 3 illustrates an applicator, generally designation 10, that utilizes a fabric material 12 to improve the ability to retain and/or release at least a portion of a substance, such as paint, stain, a cleanser, or the like. In one embodiment, the applicator 10 may be a cylindrical roller cover that is configured to slip onto a roller cage or frame (not shown) connected to a handle (not shown) to form a paint roller. However, the applicator 10 may take any of a variety of forms, such as a roller cover, bristles or foam of a brush or a broom, an application surface of an edging tool, a sponge, strands of a mop, or the like. Thus, the applicator 10 and the substance of present disclosure may be embodied in other specific forms without departing from their essential characteristics. The described embodiments are to be considered in all respects only as illustrative and not as restrictive.

The fabric material 12 is designed with a focus on the material, formulation, and/or finishing thereof. Individual fibers or filaments of the fabric material 12 may have any cross-sectional shape. The fabric material 12 may be formed partially, substantially (e.g., more than 50%) or entirely (e.g., 100%) of a synthetic fluoropolymer of tetrafluoroethylene, such as PTFE. A well-known brand name of PTFE is TEFLON®. Hybrid mixtures, such as those including PTFE and at least one additional material, may be adjusted to reduce costs, for example. In one embodiment, the PTFE fabric material 12 is not microfibers. Therefore, the PTFE fabric material 12 of the present embodiment does not exhibit the aforementioned problematic surface irregularities. In addition, the PTFE fabric material 12 is generally excellent for releasing paint because friction is reduced. The PTFE fabric material 12 retains paint through the density, nap height, and/or non-linear configuration of the fibers when applied to or formed in the applicator 10. The applicator 10 with PTFE fabric material 12 results in improved retention and/or release performance, while eliminating the need for the secondary or additional manufacturing process and the dual fiber material structure required for prior art roller covers with similar performance characteristics.

As shown in FIG. 3, the applicator 10 may include a tube core 14 having an interior surface 16 and an opposing exterior surface 18. The fabric material 12 may be attached to or integrally formed with a backing layer 20, possibly formed of fabric. The combined fabric material 12 and backing layer 20 may be adhered to or integrally formed with the tube core 14. In one embodiment, the fabric material 12 can be created in a continuous extrusion process and then cut to length. Prior to, or after, cutting, the fabric material 12 can be crimped to form bends or kinks so that the fabric material 12 is no longer completely or substantially linear. In one embodiment, the fabric material 12 can be created having a certain number of crimps per inch, such as thirteen crimps per inch. However, more or fewer crimps per unit length are possible.

The fabric material 12, after being crimped, can be woven or knitted to the backing layer 20. The fabric material 12 can have multiple fibers, flurofibers and/or filaments that are spun into a yarn that is then woven to the backing layer 20. Alternatively, the fabric material 12 can be cut to individual desired lengths of fibers that are then knitted onto the backing layer 20. In one embodiment, the backing layer 20 can be a polyester fabric weave or grid structure. A particular pile or nap height of the applicator 10 can be achieved during the knitting or weaving process. The density of the fibers on the backing layer 20 and also the density of the backing layer 20 grid can also be determined before the fibers are attached to achieve desired applicator 10 characteristics.

The tube core 14 may be made of a polypropylene material or the like. The tube core 14 can be heated and then the combined backing layer 20 and PTFE fabric material 12 can then be pulled onto the hot core while being wrapped around the core. When the core cools, the combined backing layer 20 and PTFE fabric material 12 may be bonded to the tube core 14, thereby securing the PTFE fabric material 12 to the tube core 14 and creating the applicator 10.

In one embodiment, no secondary or additional process is required to create the PTFE fabric material 12 or apply the PTFE fabric material 12 to the backing layer 20 or the tube core 14. Instead, at least a substantial portion of the fabric material 12 may be made of extruded PTFE fibers or filament, and, therefore, the applicator 10 will exhibit excellent paint release properties. For example, the fabric material 12 may be formed of a certain amount (e.g., 60%-90%) of PTFE to improve retention and/or release of a substance, and a certain amount (e.g., 40%-10%) of at least one alternative material, such as polyester and/or acrylic, to improve resiliency and/or rigidity. The density and pile or nap of the PTFE fabric material 12 on the backing layer 20, as well as the crimped structure of the fibers, can be configured and adjusted to create a desired paint retention characteristic for a given roller cover.

It is possible to split some or all of the PTFE fabric material 12 to create PTFE microfibers. For example, one embodiment could include a mixture of PTFE fabric material 12 and PTFE microfibers. However, this process may produce fibers that are too fragile and/or that have too high of a paint retention characteristic.

Prior art methods of coating microfibers with TEFLON® result in undesirable characteristics, including at least partially filling the grooves or angular formations formed in the outer periphery of each microfiber (see FIG. 2). Thus, the ability of such TEFLON®-coated fibers to retain or pick-up paint is reduced. In contrast, an embodiment of the present disclosure includes forming the microfibers at least partially or fully of TEFLON®, which allows the grooves of each microfiber to remain at least partially or completely open or unobstructed prior to contacting paint. Such an embodiment preserves the paint-retention benefits of the grooves of the microfibers, while adding the additional benefit of improved release of the paint due to the TEFLON®. Furthermore, manufacturing time and costs are reduced by such an embodiment because there is no need to subsequently coat the fibers with TEFLON®.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An applicator comprising:
a core having an interior surface and an exterior surface;
a backing layer attached to or integrally formed with at least a portion of the exterior surface of the core; and
fabric material attached to or integrally formed with at least a portion of the backing layer, the fabric material including polytetrafluoroethylene (PTFE).

2. The applicator according to claim 1, wherein the fabric material is woven or knitted to the backing layer.

3. The applicator according to claim 1, wherein fabric material includes multiple fibers spun into a yarn.

4. The applicator according to claim 3, wherein the fabric material is woven to the backing layer after being spun into the yarn.

5. The applicator according to claim 1, wherein the fabric material is cut to individual desired lengths of fibers that are then knitted onto the backing layer.

6. The applicator according to claim 1, wherein the core is cylindrical.

7. A method of forming an applicator, the method comprising:
attaching a fabric material including polytetrafluoroethylene (PTFE) to a backing layer; and
attaching the combined fabric material and backing layer to at least a portion of an exterior surface of a core.

8. The method according to claim 7, wherein the combined fabric material and backing layer are attached to the core by the application of heat.

9. The method according to claim 7, wherein no secondary process is required to attach the fabric material to the backing layer.

10. The method according to claim 7, wherein the fiber structure is formed substantially of PTFE.

11. The method according to claim 7, further comprising:
creating the fabric material in a continuous extrusion process; and
cutting the fabric material to a predetermined length.

12. The method according to claim 11, further comprising:
crimping the fabric material to form bends or kinks.

13. The method according to claim 12, further comprising:
weaving or knitting the fabric material to the backing layer.
